(19) United States
(12) Patent Application Publication
(10) Pub. No.: US 2021/0315757 A1
(43) Pub. Date: Oct. 14, 2021

(54) PATIENT PARTICULATE SPREAD PROTECTION SYSTEM AND METHODS

(71) Applicants: Hien Thai Nguyen, San Jose, CA (US); Ken Nguyen Isaka, San Jose, CA (US); Satoru Isaka, San Jose, CA (US)

(72) Inventors: Hien Thai Nguyen, San Jose, CA (US); Ken Nguyen Isaka, San Jose, CA (US); Satoru Isaka, San Jose, CA (US)

(21) Appl. No.: 17/112,929

(22) Filed: Dec. 4, 2020

Related U.S. Application Data
(60) Provisional application No. 63/008,543, filed on Apr. 10, 2020.

(51) Int. Cl. A61G 10/00

(52) U.S. Cl. CPC A61G 10/005

(57) ABSTRACT

Protective shield unit provides a portable and reusable method for protecting medical staff during patient interaction. The protective shield unit is light weight, easily deployable, simple to use and reduces the amount of PPE that is needed by each medical staff. The protective shield unit includes an overhead frame that can be collapsible and a removably attachable flexible shield wall suspended from the frame for enclosing the patient. The shield wall is attachable to the frame from the outer surface of the shield wall such that the frame does not contact the inner surface of the shield wall, thereby blocking patient particulate exposure to the frame and preventing contamination during use.

### CROSS-REFERENCE TO RELATED APPLICATION

This application claims the benefit of U.S. Provisional Application No. 63/008,543, filed on Apr. 10, 2020, which is hereby incorporated by reference in its entirety.

### FIELD OF INVENTION

The embodiment(s) of the present invention relates to a system and method for protective equipment. More specifically, the embodiment(s) of the present invention relates to a system and method for protective equipment for patient particulate spread protection.

### BACKGROUND

Patients who cough, undergo aerosolized treatment, receive positive airway pressure ventilation or intubation can extrude harmful particulates to surroundings. Since unprotected individuals near the patient are exposed to significant risks for infection, wearing personal protective equipment (PPE) is mandatory for healthcare workers. However, in time of emergency or during shortage of resources, finding enough PPEs for everyone around the patient is not guaranteed.

The type of PPE varies from a facial mask to a full protective body suit, depending on situations. PPE is essential when performing high risk and life-saving procedures in ICUs and emergency rooms. When healthcare workers treat patients who need air supplies and ventilation, full-body protective gears are recommended because there is a high risk of spreading infectious particles to the workers and surroundings. Such PPE is typically designed as individual equipment and discarded after a single use, if one doctor and three nurses are attending a patient, for example, a total of four PPEs are initially needed to attend the patient. When they leave the room to attend another patient, they must discard the used PPEs and use another set of new PPEs in order to prevent transmitting infection from one patient to another. When they return to the original patient, once again they must replace their PPEs. In this scenario, 16 PPEs in total are required for four healthcare workers to attend just two patients twice each. If the number of patients, the number of healthcare workers, and the number of visits to the patient increase, the required number of PPEs grows exponentially.

Such is the situation that is happening at medical facilities all over the world during the pandemics of Covid-19. To deal with extreme shortages and inconsistent supply of PPEs, healthcare workers are expected to reuse their PPEs. They do so by keeping them from being soiled, cleaning them between patients, or keeping the same PPEs between patients with infections of the same causative agent. Reusing PPEs is not safe. Disposable individual PPEs are safer, but expensive, wasteful, environmentally costly, and the availability can be limited in certain situations. Accordingly, there is a high need for a protective apparatus and method designed to help solve these problems.

### SUMMARY

The following summary illustrates simplified versions of one or more aspects of the present invention. The purpose of this summary is to present key concepts in a simplified manner pending more detailed descriptions later.

In various exemplary embodiments, apparatuses and methods are provided that would greatly expand protection of healthcare workers from exposure to infectious particles extruded from patients.

According to an embodiment of the present invention, there is a portable shield unit to prevent airborne particulate spread extruded from a patient. The portable shield unit comprises: a portable frame configured to suspend above a head and an upper torso of a patient, the frame having a single continuous member or a plurality of members wherein each member of the plurality of members is coupled to another member of the plurality of members; and a shield wall configured to drape from the portable frame and around at least the head and upper torso of the patient. The shield wall comprises an inner surface and an outer surface, wherein the outer surface of the shield wall is attached to the single continuous member or to the plurality of members of the portable frame, such that the portable frame avoids any contact with the inner surface of the shield wall and is thereby protected from exposure to the airborne particulate extruded from the patient.

According to another embodiment of the present invention, there is a portable shield unit to prevent airborne particulate spread extruded from a patient, the portable shield unit comprising: a portable frame, a hanging component and a fluid-impermeable barrier, wherein the barrier comprises an inner surface and an outer surface, and wherein the outer surface of the barrier is attached to the portable frame, such that the portable frame avoids any contact with the inner surface of the barrier. The portable frame comprises a single continuous member or a plurality of members. The plurality of member comprises a first member, a second member, and a third member; the first member coupled at a first junction to the second member and the second member coupled at a second junction to the third member. The hanging component connects to a top of the portable frame for suspending the portable frame at a distance above a head and an upper torso of a patient. The fluid-impermeable barrier is configured to drape from the portable frame and surround at least the head and upper torso of the patient, the barrier formed of a flexible and see-through material allowing the patient to be viewed from outside the barrier.

In a further embodiment of the present invention, there is a method of deploying a portable shield unit comprising a frame and shield wall to prevent airborne particulate spread extruded from a patient. The method of deploying comprising: (a) assembling the frame comprising a single continuous member or a plurality of members; (b) attaching an outer surface of the shield wall to an outside surface of the single continuous member or to an outside surface of one or more of the plurality of members, to create a shield unit enclosure, wherein the frame is prevented from contacting an inner surface of the shield wall; and (c) positioning the shield unit over a desired location. The step of assembling in the method may further comprise suspending the frame from an overhead structure via a hanging component connected to a top of the frame.

These features, advantages and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates a simplified perspective view of a hanging type shield unit, according to an embodiment of the present invention.

FIG. 2A illustrates a partial side perspective view of the shield unit of FIG. 1 suspended from a support structure over a patient, according to an embodiment.

FIG. 2B illustrates a side perspective view of the shield unit of FIG. 2A suspended from another type of support structure over a bed, according to an embodiment.

FIG. 2C illustrates a simplified side view of an arm insertion hole with corresponding sleeve according to an embodiment of the present invention.

FIG. 2D illustrates a rear perspective view of a shield wall showing the positioning of arm insertion holes on three sides of the shield wall according to an embodiment of the present invention.

FIG. 3 illustrates a side view of the shield unit of FIG. 1, according to an embodiment.

FIG. 4 illustrates a simplified perspective view of a rigid type shield unit, according to an embodiment of the present invention.

FIG. 5 illustrates a front perspective view of a rigid type shield unit, similar to that of FIG. 4, according to another embodiment of the present invention.

FIG. 6 illustrates a side view of the shield unit of FIG. 4, according to an embodiment.

FIG. 7 illustrates a simplified perspective view of a shield unit, according to yet another embodiment of the present invention.

FIG. 8 illustrates a side view of the shield unit of FIG. 7, according to an embodiment.

FIG. 9 illustrates a partial inside view of the shield unit over a patient, showing a healthcare professional's forearms and hands inserted through the shield wall, according to an embodiment.

FIG. 10 illustrates a view of how the shield wall and the frame can be stored in a transport cart, according to an embodiment.

FIG. 11 illustrates the shield unit hanging from an overhead structure over a bed or gurney in an enclosed position, according to an embodiment.

FIG. 12A illustrates a hanging component of a frame to be hung to an overhead structure, according to an embodiment.

FIG. 12B illustrates adjusting the hanging component, according to an embodiment.

FIG. 12C illustrates mating the hook-and-loop fasteners of the shield wall to the hook-and-loop fasteners on the underside of the frame, according to an embodiment.

FIG. 12D illustrates a detail view of FIG. 12C, according to an embodiment.

FIG. 13 illustrates the direction the shield wall should face when in use and prior to the bottom edges placed in the enclosed position, according to an embodiment.

FIG. 14 illustrates tucking the bottom edge of the shield wall under the mattress, according to an embodiment.

FIG. 15 illustrates untucking the bottom edge of the shield wall from under the mattress, according to an embodiment.

FIG. 16 illustrates detaching the shield wall from the underside of the frame, according to an embodiment.

FIG. 17 illustrates moving the shield wall over the mattress, according to an embodiment.

FIG. 18A illustrates folding each side of the shield wall towards the center, according to an embodiment.

FIG. 18B illustrates the completion of folding the shield wall along a lengthwise direction, according to an embodiment.

FIG. 18C illustrates the completion of folding the shield wall along a widthwise direction, according to an embodiment.

FIG. 19 illustrates that the frame can be stored and reused since it was not contaminated, according to an embodiment.

FIG. 20 is a flow chart illustrating a method of using the shield unit, according to an embodiment.

### DETAILED DESCRIPTION OF EMBODIMENTS

The description above and below and the drawings of the present document focus on one or more currently preferred embodiments of the present invention and also describe some optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

A system and methods for airborne particulate spread protection is described. The airborne particulate spread protection system is designed to protect people from exposure to infectious particles extruded from patients. An embodiment of the present invention is a particulate spread protective system or a unit comprising a protective tent-like shield and a supporting frame.

The system, unit and methods of the present invention is designed to protect healthcare workers or any surrounding individual from exposure to infectious particles extruded from patients. An embodiment of the present invention is a protective shield unit comprising a protective tent-like shield and a supporting frame which remains reusable and free of contamination after detachment from the shield. The terms “shield”, “shield wall”, “wall”, “cover”, “protective shield” and “barrier” can be used interchangeably as it refers to the protective covering of the shield unit. The shield unit is placed over a patient's upper torso and head, providing a particulate barrier between the patient and the surroundings.

The shield wall can be made of see-through waterproof materials, for example, a fluid-impermeable, aerosol particulate impermeable, flexible plastic sheet of one or more layers. The flexible plastic refers generally to any synthetic or semi-synthetic organic polymeric material suitable to being impermeable to fluids and aerosol particulates. The shield unit may be hung from a ceiling or an overhead support, placed on the bed or gurney with a solid frame, or comprises a mobile frame that stands on the floor and can be moved from one place to another. The shield wall may have insertion holes (also referred to as “arm insertion holes”) for healthcare workers to place their hands and forearms in order to perform procedures to the patient while minimizing exposure and outward air leakage. The arm insertion holes provide sufficient closure to prevent particulates to escape from the inside of the environment exposed to the patient to the outside environment. The arm insertion holes are openings on the shield with sleeves or holes with gaskets, zip lock (re-sealable interlocking groove and ridge press seal), or elastic band closures. There may be as many insertion holes as deemed necessary and they can be placed anywhere on the shield wall to allow access to the patient inside for the intended procedure. Once set up, the shield unit may remain in place for the duration of the patient's stay in the bed.

The construction of the shield unit is intended to be simple, and the materials are readily available in common stores, so that anyone with a basic knowledge can build the shield unit quickly and inexpensively. This makes the present invention suitable for emergency situations. At the same time, the present invention may be used as semi-permanent fixtures and tools for clinical facilities including, but not limited to, hospitals, emergency medic vehicles, nursing homes, dentists, and at home.

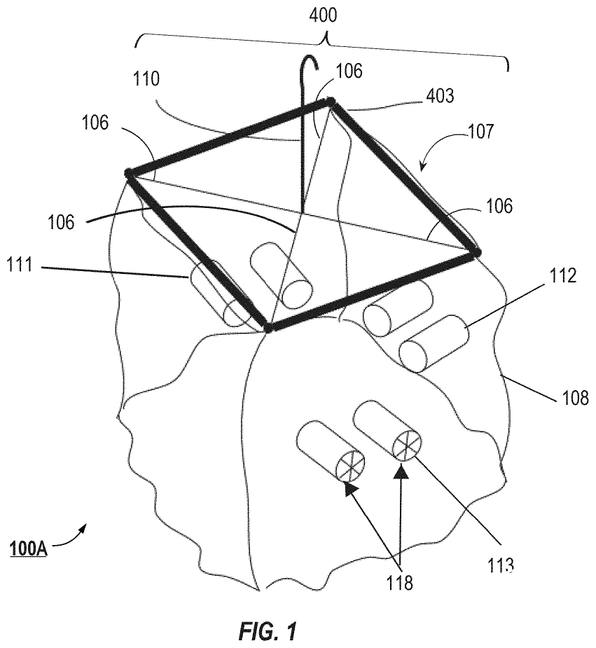

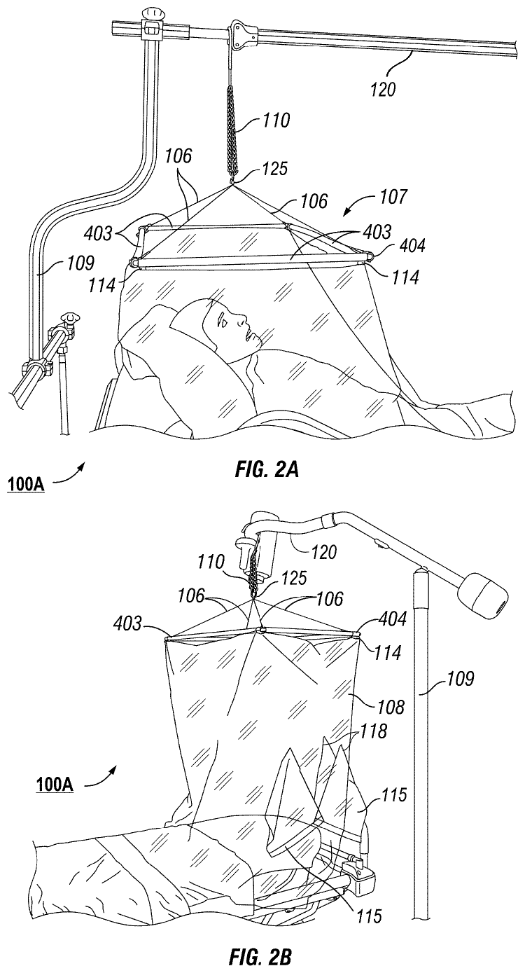

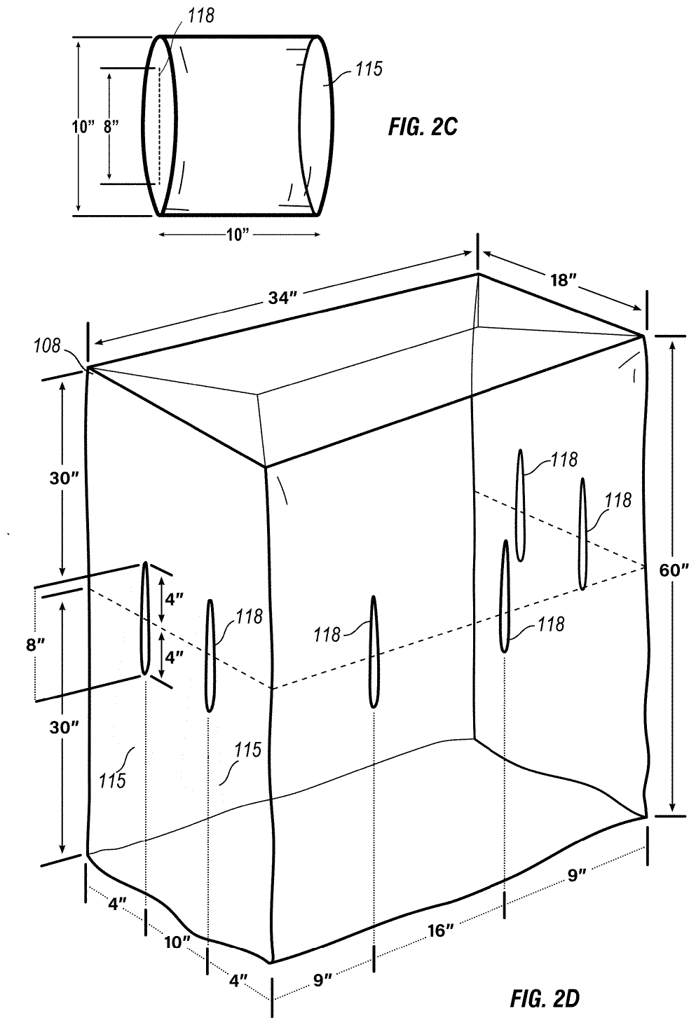

FIGS. 1-3 illustrate a simplified view of a shield unit 100A, according to an embodiment of the present invention. The shield unit 100A comprises a frame 107, a hanging component 110, and a shield wall 108. The frame 107 has an upper portion 400 configured to suspend a distance above the head of the patient and comprises one or more lateral members 403 connected to one another by a coupler 404 (see FIG. 2A). For example, a first member 403 is coupled to a second member 403 at a first junction, the second member 403 is coupled to a third member 403 at a second junction, and a fourth member 403 is coupled at a third junction to the third member 403 and coupled at a fourth junction to the first member 403. The angles at each of the first, second, third and fourth junctions may be substantially at 90 degrees. In an alternative embodiment, the upper portion 400 may comprise a single continuous structure, not intended for disconnection. The size and shape of the upper portion 400 can be adjustable. According to an embodiment, the frame 107 may be sized with a length of about 34 inches and width of about 18 inches, in other words two 34 inch lateral members and two 18 inch lateral members 403 to form a rectangular frame 107. Other types of the frame 107 shape and other dimensions for the lateral members 403 are also contemplated which for example may include other rectangular, square, circular, oval, arc-like, triangular, polygonal or open polygonal shapes, including one or more substantially straight or curved lateral members at the same or multiple levels. The lateral members 403 may be collapsible, for example one or more of the lateral members may telescopically adjust or collapse within other lateral member, or fold at flexible junctions at each corner. In some embodiments, each frame member 403 may comprise a solid rod; or each frame member comprises a hollow or tubular form; or the frame 107 may comprise combinations thereof. The couplers 404 may take the form of fittings or other socket coupling, e.g. elbow socket, tee socket. The frame 107 can be made of solid materials such as wood, metals, and plastics, for example coat hangers or PVC pipes, that are strong enough to hold the shield wall 108. According to an embodiment, each lateral member 403 may have a diameter ranging about ½ inch to about ¾ inch. The hanging component 110 can be used to hang or suspend the shield unit 100A from a ceiling (overhead structure 120) or hanging post/supporting stand 109 as illustrated in FIGS. 2A and 2B.

The hanging component 110 can be adjustable and can be made from various materials such as plastic, metal, etc. Embodiments of a hanging component 110 can be a chain, rod, cord, terminating at one end (the top end) with a hook/latch or a ring to engage the overhead structure and connected at the other end (the bottom end) to the top surface of the frame 107. As shown, according to an embodiment, the top surface of the frame 107 comprises a number of suspension cords 106 (rod/wire/components which may be flexible or rigid) that extend out from and connect at the corners of the frame 107. For example, four suspension cords 106 emanate from the corners of the frame 107 and converge toward the center at the top of frame with a connector loop 125 to connect to the bottom end of the hanging component 110. According to an embodiment, the connector loop 125 has a diameter of about 1 inch. When suspended, each suspension cord 106 extends at an angle to the corner/junction of the frame 107. The suspension cords 106 may also attach to or extend from other parts of the frame 107. The hanging component 110 may rotatably or slidably engage the overhead structure or supporting stand 109; or may rotatably engage the top of the frame 107, for example at the center convergence connector loop 125 of the suspension cords 106 or at the top end of the hanging component near the hook, to provide flexibility in adjusting the positioning of the suspended shield wall 108.

The shield wall 108 of the shield unit 100A can be made of a see-through, waterproof material such as plastic or any material that does not allow fluids or aerosols particulates to pass through. The material can also be transparent microfiber. To create an air barrier/enclosure between the patient's upper body and the surroundings, the shield wall 108 covers over the patient, specifically, the shield wall 108 covers the patient's torso and head. The lower part of the shield wall 108 is protected by the bed to complete the enclosure. The three sides (left, right, back) of the shield wall 108 can be draped over or tucked underneath the bed, and the front side can be secured over the patient torso and arms. However, other ways of enclosing the shield wall 108 can be used such as clips, hook-and-loop fastener, tape, elastic edges, etc.

As shown in FIG. 1, the shield wall 108 may have one or more arm insertion holes 118. Optionally, the shield wall 108 may have arm insertion holes 118 on the left side 111, front side 112, and right side 113 of the shield wall 108 for insertion of hands and forearms from the outside of the shield wall 108 for the purpose of accessing the patients for procedures and manipulations. When not in use, the arm insertion holes 118 can be closed to keep the shield wall 108 airtight.

FIG. 2A illustrates a partial side perspective view of the shield unit 100A of FIG. 1, according to an embodiment of the present invention. There is a supporting stand 109 with an overhead structure 120 that the hanging component 110 hangs on. The supporting stand 109 can be mobile or connected to the frame of the bed or chair. The height of the hanging component 110 is adjustable. As illustrated in FIG. 2A, the hanging component 110 is connected to the corners of the frame 107 via suspension cords 106. The outside of the shield wall 108 attaches to the outside or underside of the frame 107 by fastener 114 including hook and loop fasteners, clips, or the like for example at the corners where the lateral members 403 meet. The shield wall 108 is shown draped over and around a patient. FIG. 2B illustrates a side perspective view of the shield unit of FIG. 2A suspended from another type of support structure 109 over a bed, for example hooking the hanging component 110 on a mobile overhead light structure 120, according to an embodiment of the present invention. The shield wall 108 includes a plurality of arm insertion holes 118 which may further extend into or out from the shield wall 108 as sleeves 115.

According to embodiments of the present invention, as illustrated in FIG. 2C, each sleeve 115 may extend a length of about 10 inches from the arm insertion hole 118. Each sleeve 115 may also surround the arm insertion hole 118 with a larger diameter than the diameter of the insertion hole 118. For example, the sleeve diameter may be sized at about 10 inches or equal to the length of the sleeve 115; the diameter of the arm insertion hole 118 may be sized at about 8 inches. There may be two arm insertion holes 118 with corresponding sleeves 115 on each side of the shield wall 108 except for the front facing side, for example, a total of six arm insertion holes 118 and sleeve 115. Other configurations are also possible.

As further illustrated in FIG. 2D, an exemplary embodiment of the shield wall/tent 108 with possible dimensions is described. According to the embodiment, there is a rectangular configured shield wall 108, with arm insertion holes 118 on the side surfaces and the rear facing surface. The shield wall 108 may be sized at about 34 inches by 18 inches to correlate to the size of the frame 107; and may have a height of about 60 inches. The arm insertion holes 118 are longitudinally situated at a centerline of the height of the shield wall 108, i.e. centered at about 30 inches from either end of the height of the shield wall 108. On each of the shorter side surfaces (left and right side), each of two arm insertion holes 118 is positioned laterally about four inches from each edge and separated from one another by about ten inches. Along the longer rear facing side, each of the two arm insertion holes 118 are positioned laterally about nine inches from each edge and separated from one another by about sixteen inches. Other dimensions and configurations are possible.

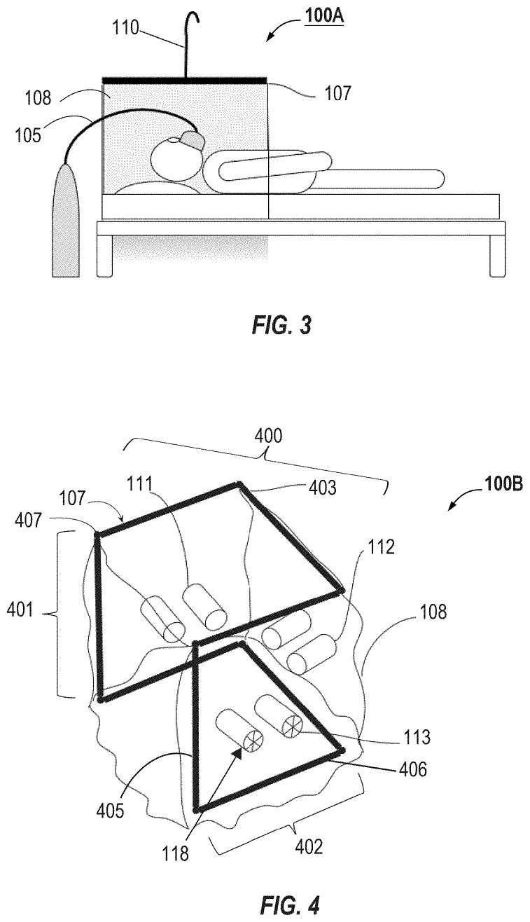

FIG. 3 illustrates a side view of the shield unit 100A of FIG. 1, according to an embodiment. FIG. 3 illustrates an embodiment of the present invention, where the shield unit 100A is supported by hanging from a ceiling or a supporting stand 109 (see FIGS. 2A and 2B). The shield wall 108, in an embodiment, has an opening through which to feed the supply line 105 without compromising the enclosure. In other embodiments, the shield wall 108 may be formed without a dedicated opening for the supply line, in which case the supply line is placed over the bed, and the shield wall drapes over the supply line. The draped shield wall may then be tucked under the bed to secure the supply line in place.

According to another embodiment of the shield unit 100A the frame 107 is integrated or built-into the shield wall 108 (such that the frame 107 is also disposable), having a central connection point, such as connector loop 125, to the hanging component 110. For example, a disposable frame 107 can be incorporated as part of the shield wall 108 at the top, as an internal skeleton, similar to plastic boning or collar stays within sleeves/pockets along edges of the shield wall 108 to provide tension to extend the shield wall 108 in a desired rectangular configuration or other tent-like configuration to surround the patient. At the outside top surface, a central tab or loop may latch to the same hanging component 110 to an overhead structure or stand.

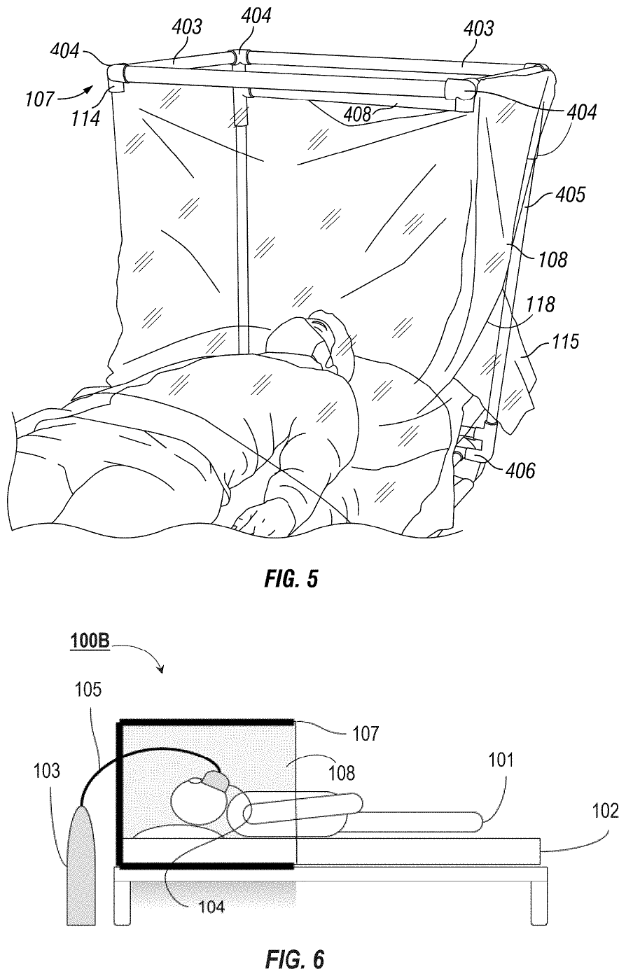

The following description refers to FIGS. 4-6. FIG. 4 illustrates a simplified view of a shield unit 100B, according to another embodiment of the present invention. The shield unit 100B comprises a frame 107 and a shield wall 108. In some embodiments as the one shown in FIG. 4, the frame 107 comprises an upper portion 400, middle portion 401, and lower portion 402. The upper portion 400 is configured to suspend a distance above the head of the patient and comprises a plurality of lateral members 403, each lateral member 403 is connected to another lateral member 403 with a coupler 404 (see FIG. 5) at a junction 407. For example, a first member 403 is coupled to a second member 403 at a first junction 407 and the second member 403 is coupled to a third member 403 at a second junction 407. The angles at each of the first, second, and third junctions 407 may be substantially at 90 degrees. The lateral members are sturdy enough to extend across the patient and support the suspension of the shield wall. In some embodiments, each lateral member may comprise a solid rod. In other embodiments, each lateral member comprises a hollow or tubular form. The couplers 404 may take the form of fittings or other socket coupling, e.g. elbow socket, tee socket, etc. The upper portion 400 of the frame 107 can have a shape substantially similar to an open three-sided polygon; however, other shapes and sizes can be contemplated such as a U-shape/C-shape. The size and shape of the upper portion 400 can be adjustable. The lateral members may be collapsible, for example one or more of the lateral members may telescopically adjust or collapse within other lateral member, or fold at flexible junctions at each corner. In yet other embodiments, the upper portion 400 may comprise a single continuously formed frame.

As illustrated in FIG. 4, there is a middle portion 401 comprising supporting members 405. In other words, the supporting members 405 are positioned or extend below the lateral members 403. A supporting member 405 can connect to a lateral member 403 with a coupler 404 at a junction 407 at an upper end of the supporting member 405. The supporting member 405, which may be substantially vertical, supports the upper portion 400 at a height which is conducive to the situation at hand, for example a working distance above the patient. The supporting member 405 can be adjustable, e.g. in the vertical direction, as such it can extend or contract when the medical professional needs the shield unit 100B to be further away from or closer to the patient 101.

There is a lower portion 402 of the frame 107 which comprises mounting members 406, which are coupled to the supporting member 405 for example at a lower end of the supporting member 405 with a coupler 404. The mounting members 406 can mount to anything that a patient rests on, for example, a bed, gurney, frame, chair, etc. For example, the frame 107 can mount onto a bed or gurney on top of the bed frame and under the mattress to hold it in place. The lower portion 402 is adjustable and can be resized depending on what the frame 107 needs to be mounted on.

The frame 107 can be made of solid materials such as wood, metals, and plastics, for example coat hangers or PVC pipes, that are strong enough to hold the shield wall 108. For example, in some embodiments, each frame member may comprise a solid rod; or each of the frame members may comprise of hollow or tube-like form; or may comprise combinations thereof. According to an embodiment, each lateral member 403 may have a diameter ranging about ½ inch to about ¾ inch. The coupler 404 (see FIG. 5) can be one that is used to connect PVC pipes or anything similar. Preferably, the coupler 404 uses a friction fit connection; however, other methods such as a screw connection, pin and hole connection can be used.

As illustrated in FIGS. 4-6, the shield wall 108 can be made of a see-through, waterproof material such as plastic or any material that does not allow fluids or aerosols to pass through. According to embodiments, the shield wall 108 is a fluid-impermeable and translucent to transparent (clear) flexible barrier such that the patient enclosed by the shield wall 108 is viewable from outside the shield wall 108. According to an embodiment, the material can be transparent microfiber. To create an air barrier/enclosure between the patient's upper body and the surroundings, the shield wall 108 covers over the patient, specifically, the shield wall 108 covers the patient's torso and head. The shield wall 108 can also be made large enough to include more or all of the patient's body. As illustrated in FIG. 4, the shield wall 108 may have one or more arm insertion holes 118 located on the periphery of the shield wall. Optionally, the shield wall 108 may have arm insertion holes 118 on the left side 111, back side 112, and right side 113 of the shield wall 108 for insertion of arms from the outside of the shield wall 108 for the purpose of accessing the patients for procedures and manipulations. Arm insertion holes 118 can be placed in any position and in any number desired for the purpose of the intended procedure. Arm insertion holes 118 may also continue inward toward the patient in a sleeve-like extension, also referred to as “sleeves” 115. When not in use, the arm insertion holes 118 can be closed to keep the shield wall 108 airtight.

FIG. 5 illustrates a front perspective view of a shield unit similar to the shield unit 100B of FIG. 4, according to an embodiment. The frame 107 is placed onto the bed and secured by its base legs by inserting the base legs between the bed frame and the mattress. As illustrated, the shield wall 108 does not cover the frame 107. Instead, only the outer surface of the shield wall 108 is removably attached to the underside or outside of the lateral members 403 using various types of fasteners 114 at attachment points. In this embodiment, a first member 403 is coupled to a second member 403 at a first junction 407 via a coupler 404, the second member 403 is coupled to a third member 403 at a second junction 407 via a coupler 404, and a fourth member 403 is coupled at third junction 407 to the third member 403 via a coupler 404 and coupled at a fourth junction 407 to the first member 403 via a coupler 404. The angles at each of the first, second, third and fourth junctions 407 may be substantially at 90 degrees. Furthermore, one or more secondary lateral members 408 next to the uppermost primary lateral members 403 is provided for additional stability. As shown, the secondary lateral member 408 is located a distance below the primary lateral member 403 at the head side of the frame 107. The secondary lateral member 408 may be connected at each of its ends to supporting members 405, for example via couplers 404. The inner surface of the shield wall 108 does not contact the frame 107 surfaces, this prevents the frame 107 from getting contaminated and allows it to be reused instead of being disposed. Only the shield wall 108 is thrown away, reducing waste and saving money. Clips can be used to connect/attach the outside of the shield wall 108 to the lateral member(s) 403 and/or secondary lateral member(s) 408, however, other fasteners 114 can be used such a hook-and-loop fastener, tape, ties, plastic sleeves, pockets or rings/tabs protruding from the shield wall to latch to receiving parts (hooks/channels/tabs) on the frame, etc. and vice-versa, at the attachment points. The attachment points are variable based on the bed dimensions and the patient positions in the bed. As shown in FIG. 5, the lower part of the shield wall 108 is protected by the bed and mattress to complete the enclosure. The three sides (left, right, back) of the shield wall 108 can be draped over or tucked underneath the bed and mattress, and the front side can be secured over the patient's torso and arms or other parts of the body or bed. However, other ways of enclosing the shield wall 108 can be used such as clips, hook-and-loop fastener, tape, elastic edges, etc.

The mounting members 406 mount to the frame of the bed by inserting the bottom part of the frame into the space between the bed and mattress to the point desired to cover the head and upper torso or other parts of the patient. The mounting member 406 is located at a distance from the bed frame in order to cover the head and upper torso or other parts of the patient. The mounting member 406 can be adjustable and resizable. According to embodiments, each mounting member 406 is connected/coupled to a supporting members 405, for example with a coupler 404.

FIG. 6 illustrates a side view of the shield unit 100B of FIG. 4, according to an embodiment. FIG. 6 illustrates how one embodiment of the present invention can be used in an environment. A patient 101 is lying on the bed 102. The patient 101 may be hooked up to an oxygen source 103 via a mask or cannula 104 and a supply line 105. The shield unit 100B is placed over a patient's upper torso and head, providing an air barrier between the patient 101 and the surroundings. In this example, the shield unit 100B is supported by a frame 107 that sits on the bed structure.

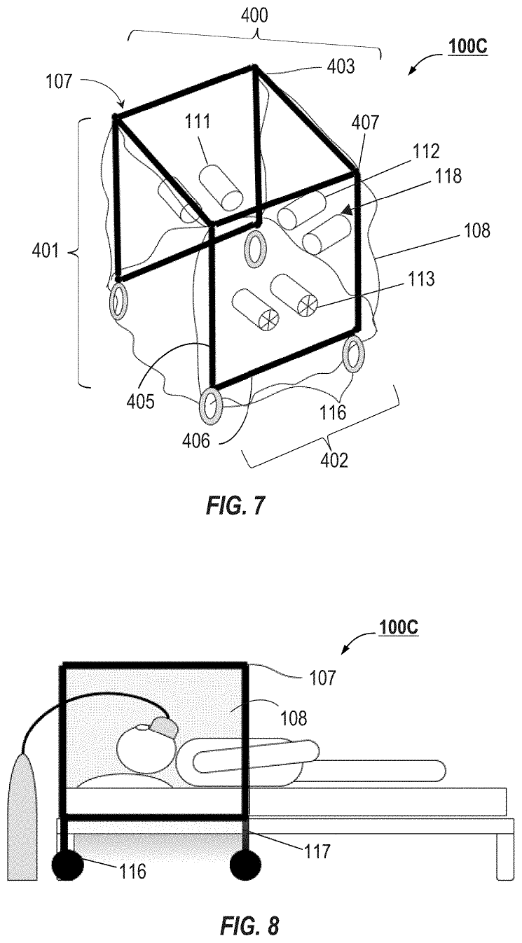

FIG. 7 illustrates a simplified perspective view of a shield unit 100C, according to yet another embodiment. The shield unit 100C comprises a frame 107 and shield wall 108. The frame 107 has an upper portion 400, middle portion 401, and lower portion 402. The upper portion 400 is configured to suspend a distance above the head of the patient and comprises a plurality of lateral members 403, each lateral member 403 is connected to another lateral member 403 with a coupler 404 (see FIG. 5) at a junction 407. For example, a first member 403 is coupled to a second member 403 at a first junction 407 via a coupler 404, the second member 403 is coupled to a third member 403 at a second junction 407 via a coupler 404, and a fourth member 403 is coupled at third junction 407 to the third member 403 via a coupler 404 and coupled at a fourth junction 407 to the first member 403 via a coupler 404. The angles at each of the first, second, third and fourth junctions 407 may be substantially at 90 degrees. The upper portion 400 of the frame 107 can have a shape substantially similar to a square; however, other shapes and sizes can be contemplated. The size and shape of the upper portion 400 can be adjustable. The lateral members may be collapsible, for example one or more of the lateral members may telescopically adjust or collapse within other lateral member, or fold at flexible junctions at each corner. In yet other embodiments, the upper portion 400 may comprise a single continuously formed frame. There is a middle portion 401 comprising supporting members 405, i.e. the supporting members 405 are located below or extend below the lateral members 403. A supporting member 405 can connect to a lateral member 403 with a coupler 404 at a junction 407, at an upper end of the supporting member 405. The supporting member 405, which may be substantially vertical, supports the upper portion 400 at a height which is conducive to the situation at hand. The supporting member 405 can be adjustable, e.g. in the vertical direction; as such it can extend or contract when the medical professional needs the shield unit 100C to be further away from or closer to the patient 101. There is a lower portion 402 of the frame 107 which comprises mounting members 406 which are coupled to the supporting member 405 for example at a lower end of the supporting member 405 with a coupler 404. The mounting members 406 can be connected to wheels 116 making it possible to roll the frame 107 from place to place. The mounting members 406 can simply rest on legs 117 against the ground or any surface without wheels as well. The lower portion 402 is adjustable and can be resized depending on the needs of the medical professional and patient.

The frame 107 can be made of solid materials such as wood, metals, and plastics, for example coat hangers or PVC pipes, that are strong enough to hold the shield wall 108. For example, in some embodiments, each frame member may comprise a solid rod; or each of the frame members may comprise of hollow or tube-like form; or may comprise combinations thereof. According to an embodiment, each lateral member 403 may have a diameter ranging about ½ inch to about ¾ inch. The coupler 404 (see FIG. 5) can be one that is used to connect PVC pipes or anything similar. The couplers 404 may take the form of fittings or other socket coupling, e.g. elbow socket, tee socket etc.

As illustrated in FIGS. 7-8, the shield wall 108 can be made of a see-through, waterproof material such as plastic or any material that does not allow fluids or aerosols particulates to pass through. The material can also be transparent microfiber. To create an air barrier/enclosure between the patient's upper body and the surroundings, the shield wall 108 covers over the patient, specifically, the shield wall covers at least the patient's torso and head. The lower part of the shield wall 108 is protected by the bed to complete the enclosure. The three sides (left, right, back) of the shield wall 108 can be draped over or tucked underneath the bed, and the front side can be secured over the patient torso and arms. However, other ways of enclosing the shield wall 108 can be used such as clips, hook-and-loop fastener, tape, elastic edges, etc.

As illustrated in FIG. 7, the shield wall 108 can have one or more arm insertion holes 118. Optionally, the shield wall 108 can have arm insertion holes 118 on the left side 111, front side 112, and right side 113 of the shield wall 108 for insertion of hands and forearms from the outside of the shield wall 108 for the purpose of accessing the patients for procedures and manipulations. When not in use, the arm insertion holes 118 can be closed to keep the shield wall 108 airtight.

FIG. 8 illustrates a side view of the shield unit of FIG. 7, according to an embodiment, where the shield unit 100C is supported by legs 117 or wheels 116. In this way, the shield unit 100C can be moved from one place to another. When the patient 101 is moved to another location, or when the bed linens are replaced, the shield unit 100C can be easily moved to facilitate the situation.

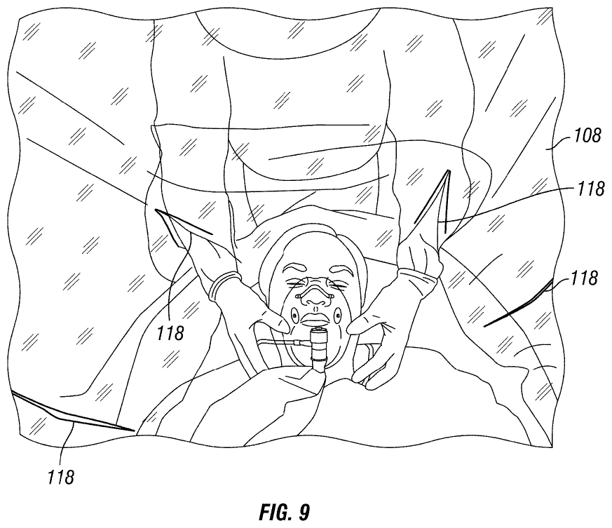

FIG. 9 illustrates the insertion holes 118 on a shield wall 108, which is applicable to all types of shield units including 100A, 100B, and 100C, according to an embodiment of the present invention. The medical worker can insert their hands and forearms through the insertion holes 118 to gain access to the patient without exposing themselves or the outside environment to the infectious particles. The forearms and hands are inserted through the insertion hole 118 to perform procedures on the patient. In the embodiment shown in FIG. 9, the insertion holes 118 are similar to sleeves of the same material as the shield wall 108 and extend as sleeve at a length from the shield wall 108. According to embodiments, the arm insertion holes 118 may include gaskets, zip lock sealing (re-sealable interlocking groove and ridge press seal), or elastic band closures. In another embodiment, the insertion hole 118, can have a protective barrier comprising a ring, gasket with slits, and secure holes for connection. The ring may be secured to the shield wall by placing two pieces of the rings from the inside and the outside and securing the rings with push pins through the secure holes. However, other types of connectors including adhesives can be used besides push pins. The gasket has slits so that arms and objects can go through the gasket to access the inside of the enclosed environment created by the shield unit 100. The gasket can be made of flexible, waterproof materials, such as silicone rubber. The ring can be made of lightweight, solid materials, such as acetal plastic. See FIGS. 2C and 2D for further illustration of the configuration of arm insertions holes 118 and sleeves 115 on the shield wall 108 according to embodiments of the present invention.

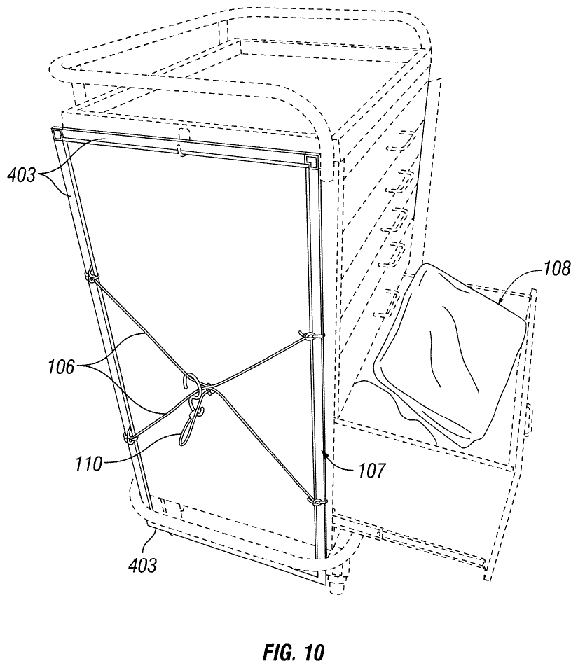

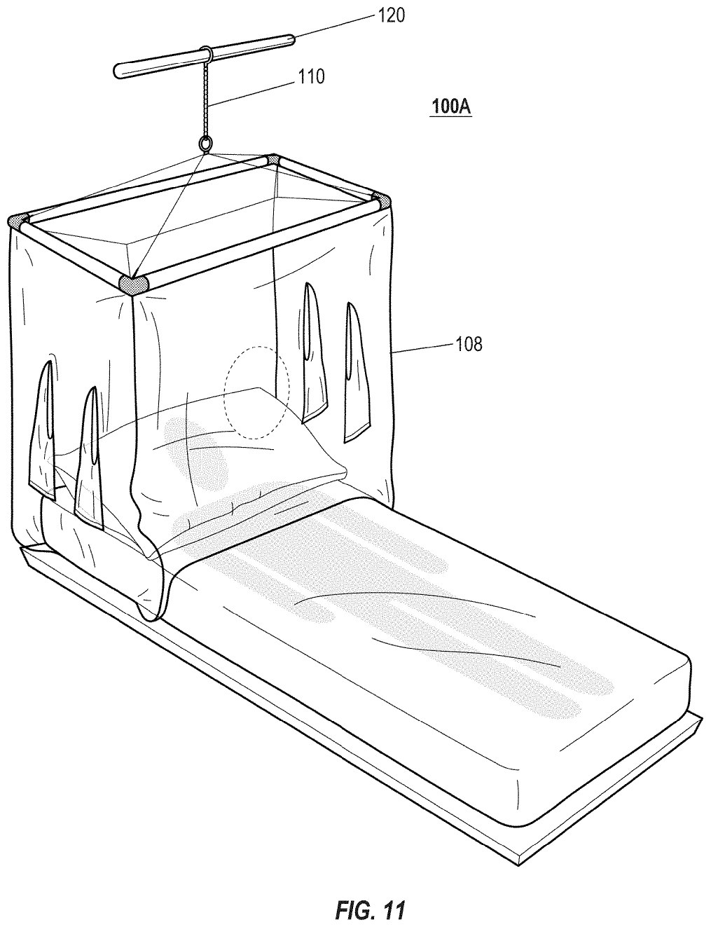

FIG. 10 illustrates how the frame 107 and shield wall 108 can be stored and transported. The size and lightweight nature of the frame 107 and shield wall 108 allows for easy storage and quick deployment. As shown in FIG. 10, the shield wall 108 can be easily folded and stored in a drawer, for example of a mobile cart, and the frame 107 can be stored against a side of the drawer without interfering with the medical staff. This is only one of many possible methods of storing the present invention.

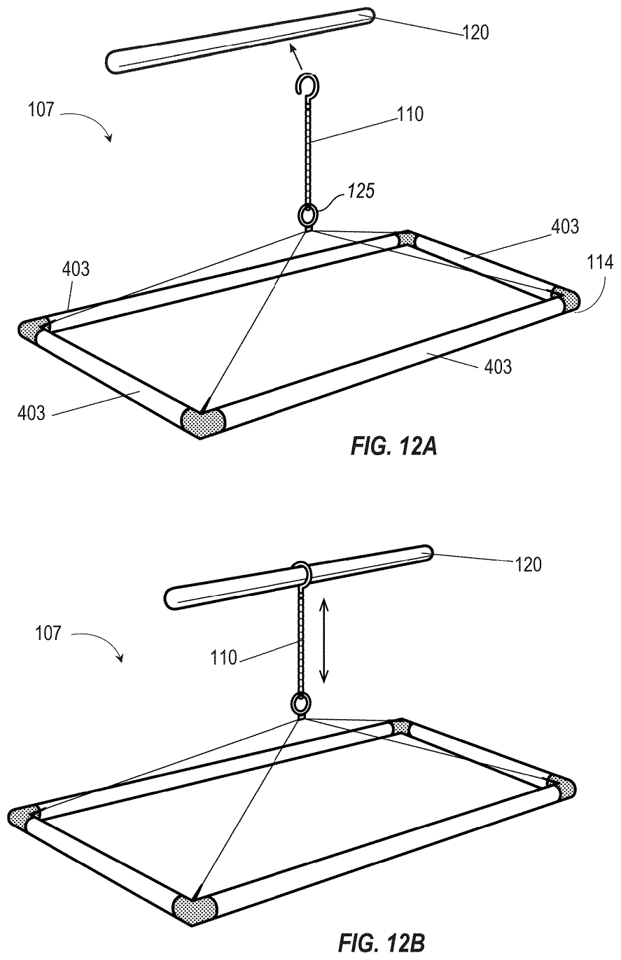

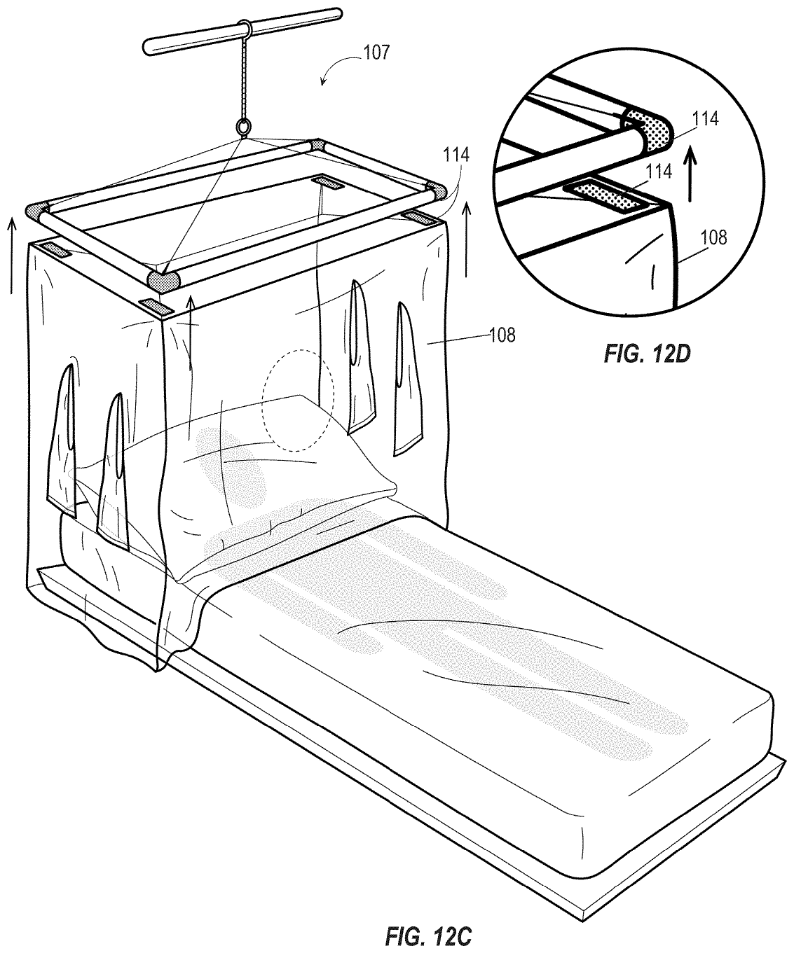

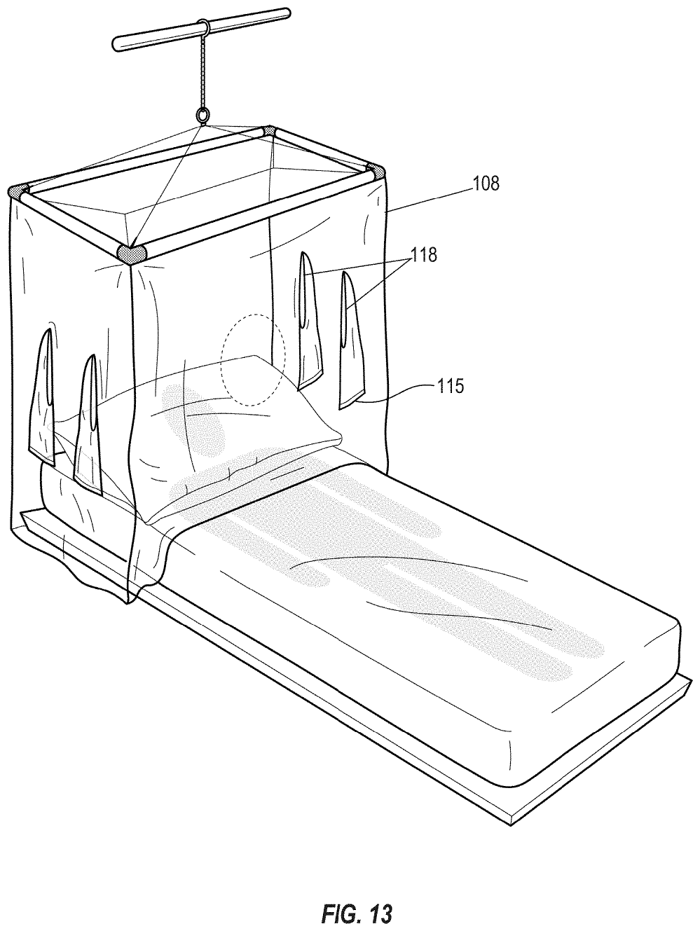

FIGS. 11-19 illustrate the deployment and removal of the shield unit 100A, according to an embodiment of the present invention. However, similar methods of deployment and removal can be applied to shield unit 100B and shield unit 100C. As shown in FIG. 11, the hanging component 110 of the shield unit is hung to an overhead structure 120 (which may also be a supporting stand 109) over a bed or gurney and is illustrated in an enclosed position. As shown the lower edges of the shield wall 108 are tucked under the bed mattress to form a seal around at least the upper torso and head of a patient, and/or may be tucked to form a seal around more of or all of the body of a patient. As shown in FIG. 12A the hanging component 110 is used to hang the frame 107, via connector loop 125, from an overhead structure 120. The shield wall 108 is connected to the frame 107 and configured to be positioned over the upper side (head end) of a patient bed or gurney. In this embodiment, the fasteners 114 are hook-and-loop used to connect the lateral members 403 to the shield wall 108. As shown, the hook-and-loop fasteners face downward, i.e. hook-and-loop fasteners reside at the top outer surface of the shield wall 108 to engage the corresponding hook-and-loop fastener underneath the frame 107. It is preferable to avoid hooking the hanging component 110 on items that easily twist and turn. Rather, the hanging component 110 should be hung on a sturdy structure such as an ortho reduction stand, sturdy overhead light arm, or another type of stand. As shown in FIG. 12B, the length of the hanging component 110 is adjusted to the appropriate height. The hanging component 110 is positioned so that the center of the frame 107 is located below the hanging component 110. FIG. 12C illustrates the step of unfolding the shield wall 108 and mating the hook-and-loop fasteners 114 of the shield wall 108 to the hook-and-loop fasteners 114 of the frame 107. After unfolding the shield wall 108 the user finds the hook-and-loop fastener located on the top four corners of the shield wall 108. The shield wall 108 is pulled apart by holding the four corners of the shield wall 108 to form/open up the final shape of the shield wall 108. In the embodiment of FIG. 12C, the final shape is substantially a rectangle, however, as discussed with regard to the shape of the frame 107, other alternative shapes of the draped shield wall 108 are possible including circular, oval, arc-like, triangular and other polygonal shapes. Then the fasteners 114 of the frame 107 located on the underside of the frame 107 are attached to the hook-and-loop fasteners 114 located on the corners of the shield wall 108 by matching up the corresponding hook-and-loop fasteners 114. FIG. 12D illustrates a detail view of FIG. 12C showing more clearly the mating between the underside of the frame 107 with the shield wall 108. The shield wall 108 is brought in an upward direction towards the underside of the frame 107 and attached underneath the frame 107 to avoid contamination. The fasteners 114 are shown to be located at the four corners; however, they may be located anywhere along the underside/outside of the frame 107 so long as they mate with the fasteners located on the shield wall 108. A plurality of fasteners 114 or just one fastener 114 can be used.

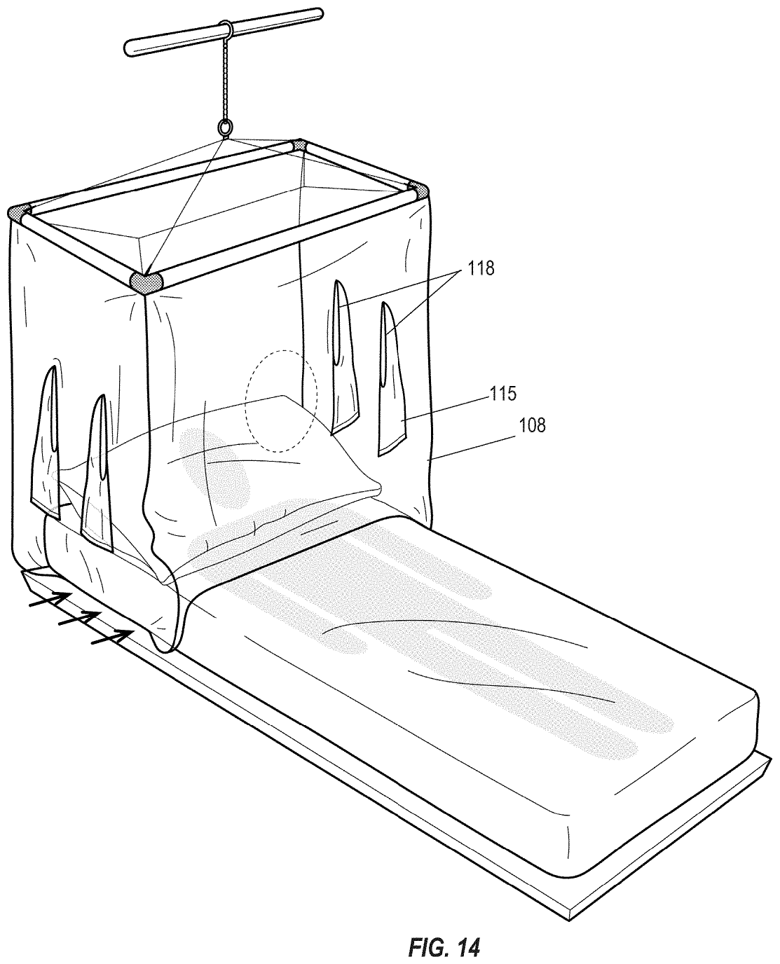

As shown in FIG. 13, once the shield wall 108 is attached to the frame 107 and suspended, the bottom edges of the shield wall 108 drape loosely a distance past the bed mattress. As shown, there are one or more intubation sleeves 115 extending from corresponding arm insertion holes 118. The medical professional should ensure that the shield wall 108 is turned or positioned so that the intubation sleeves 115 face behind the patient (e.g. at the head of the gurney/bed) when intubating. FIG. 14 illustrates tucking the bottom edge of the shield wall 108 under the mattress. When possible, all airway equipment is placed inside the area that the shield wall 108 will drape over. The equipment should be set up before putting the shield wall 108 over the patient. If not, the equipment can be passed under the shirt of the shield wall 108. After ensuring the patient is on oxygen and that the suction is turned on, the edge of the shield wall 108 is tucked under the mattress and where possible giving the shield wall 108 some slack.

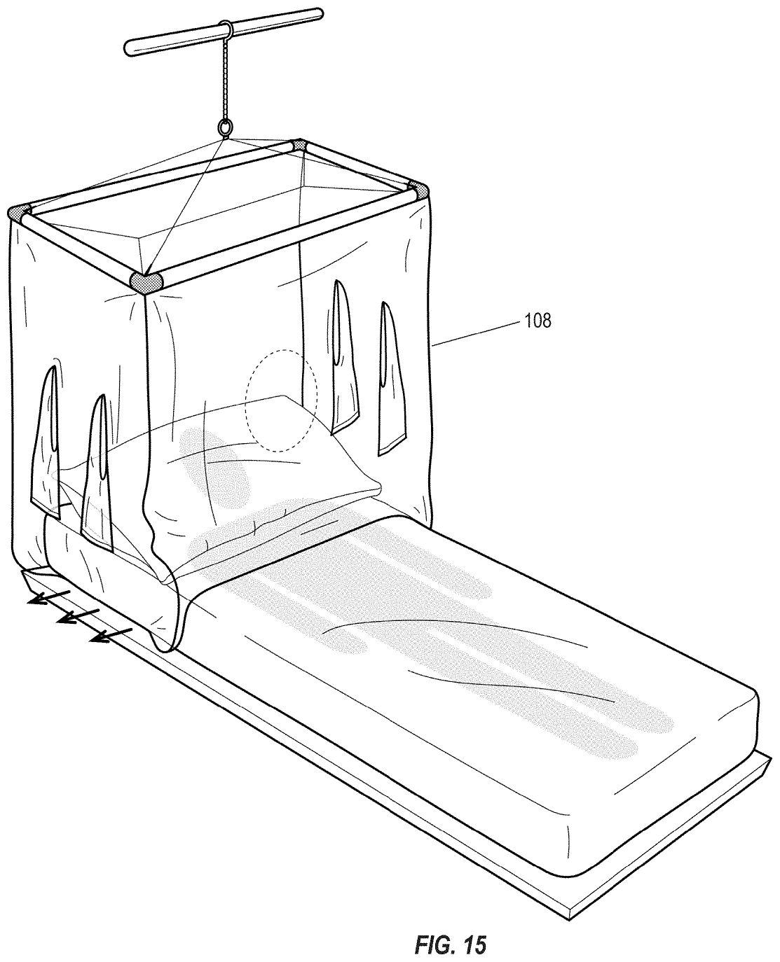

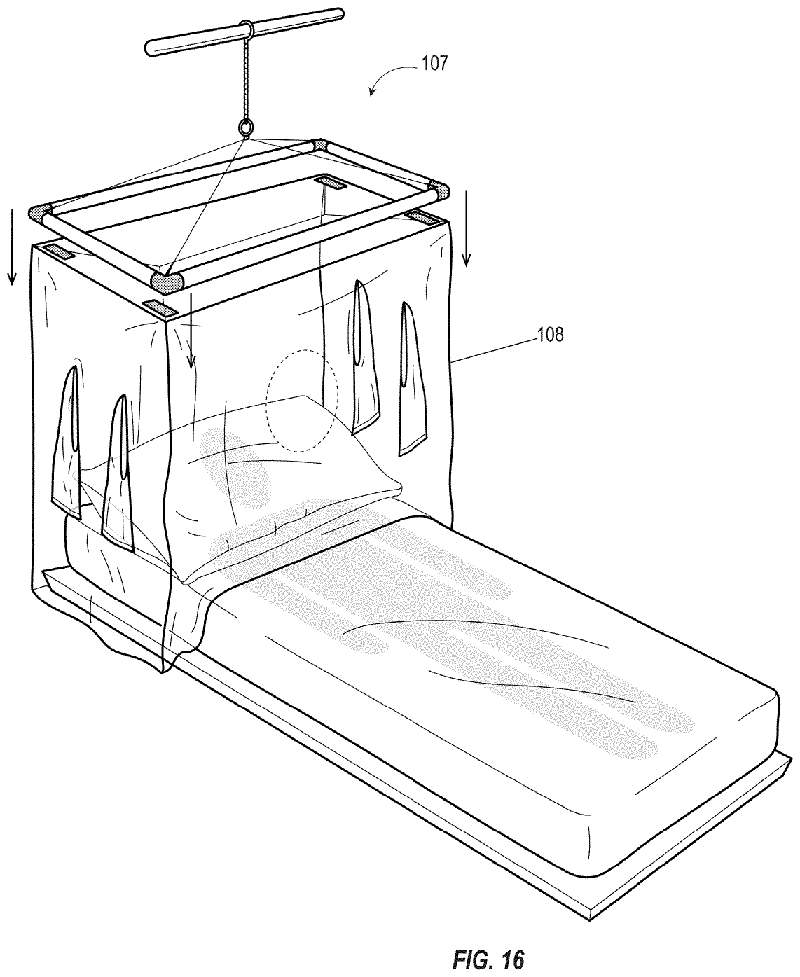

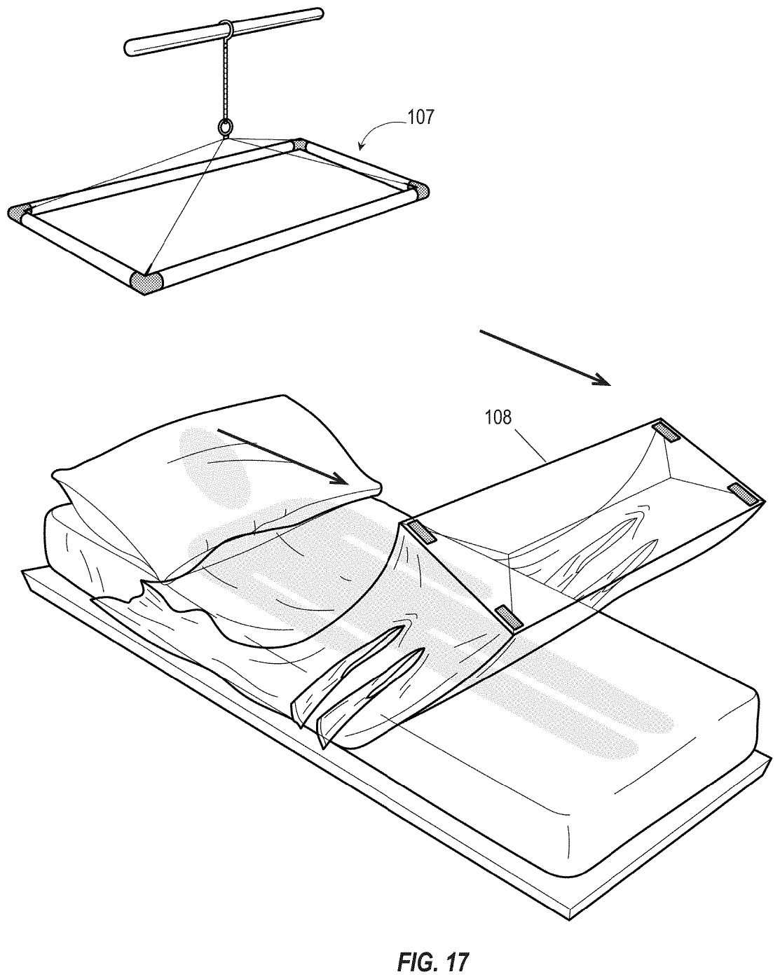

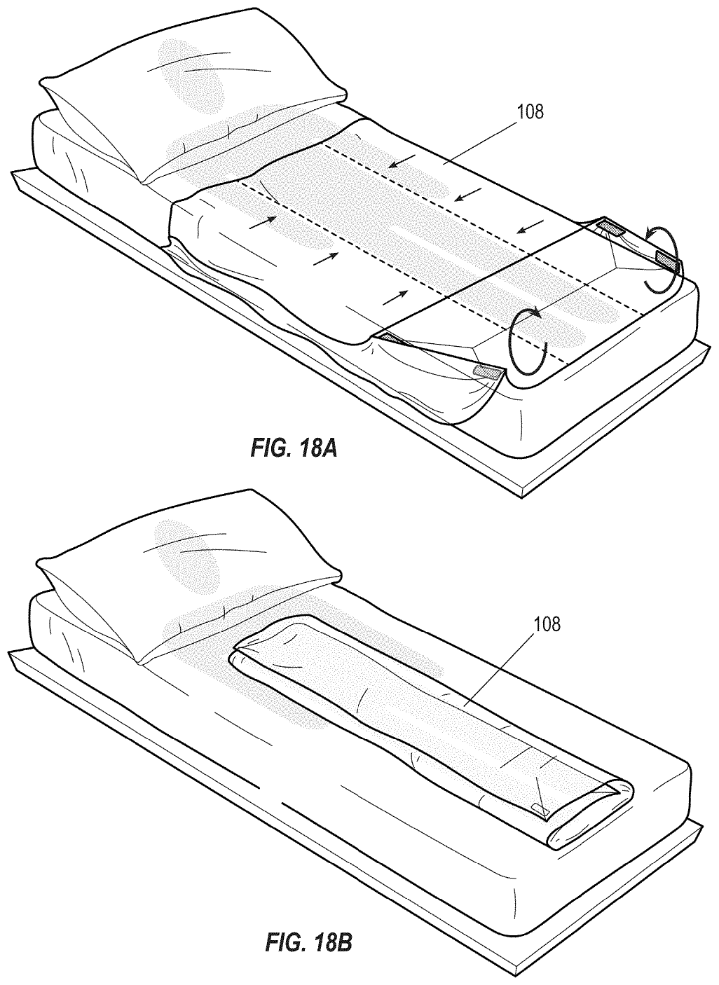

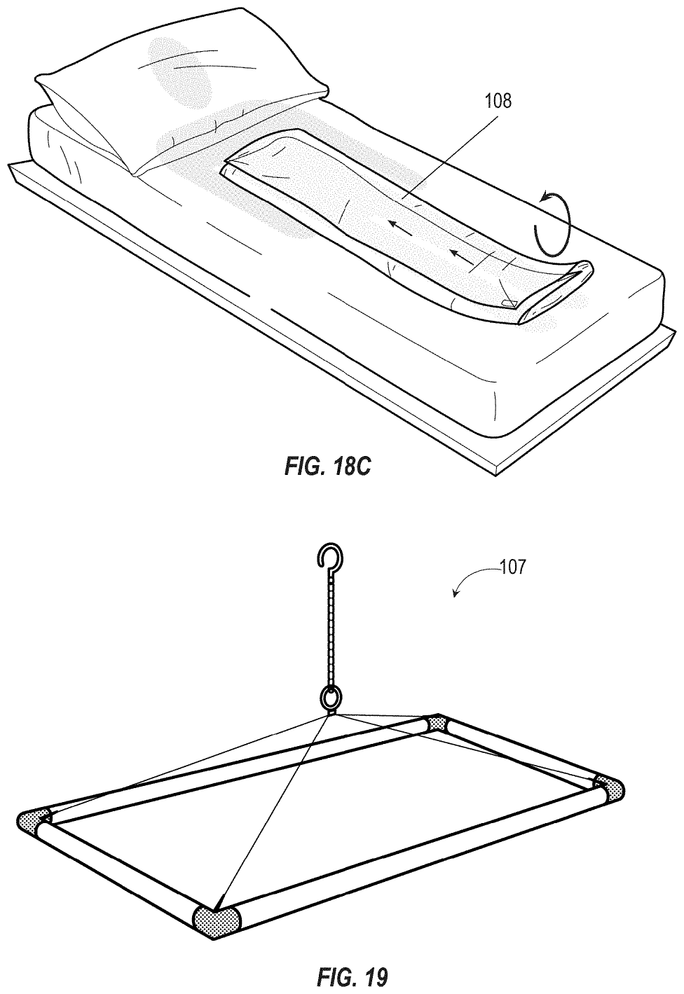

FIGS. 15-19 illustrate the removal of the shield unit 100A, according to an embodiment of the present invention. Upon completion of the medical procedure, it is recommended that the shield unit 100A be allowed to remain hanging for about 10-20 minutes when possible. FIG. 15 illustrates untucking the bottom edge of the shield wall 108 from under the mattress. FIG. 16 illustrates the step of detaching the shield wall 108 from the underside of the frame 107 by pulling the shield wall 108 in a downward direction. Once the shield wall 108 is detached, the shield wall 108 is moved over the mattress so that it can be folded on the mattress, as shown in FIG. 17. FIG. 18A illustrates folding each side of the shield wall 108 towards the center along a lengthwise direction, according to an embodiment. FIG. 18B illustrates the completion of folding the shield wall 108 along a lengthwise direction. Then the shield wall 108 is further folded along a widthwise direction as shown in FIG. 18C and is then disposed. FIG. 19 illustrates that the detached frame 107 can then be stored away and reused again because it was not contaminated since the shield wall 108 was connected from the outside of the shield wall 108 to the underside of the frame 107.

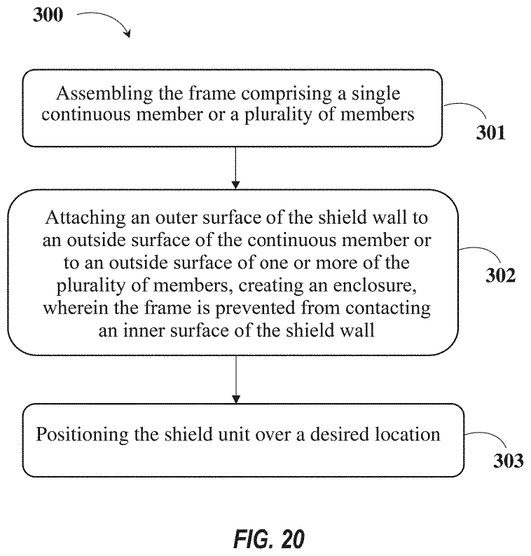

FIG. 20 illustrates a flow chart describing a method of using the shield unit 300, according to an embodiment, comprising at least the following steps: Step 301, assembling the frame 107 if it is not already constructed (such as a single continuously formed member), by using a plurality of members (and couplers 404); Step 302, securely attaching the outer surface of the shield wall 108 to an underside/outside of the erected frame 107 to create an enclosure; and Step 303, positioning the shield unit over the desired location. The step of assembling 301 may further comprise at least connecting a first member to a second member using a first coupler and connecting a second member to a third member using a second coupler. The step of assembling 301 may further comprise connecting the third member to a fourth member using a third coupler and connecting the fourth member to the first member using the first coupler. The step of assembling 301 may further comprise suspending/hanging the frame from an overhead structure or stand by using a hanging component that is connected to a top of the frame. According to an embodiment, the step of attaching 302 comprises using one or more hook-and-loop fasteners. The step of positioning 303 may further comprise moving the shield unit over an upper torso and a head of the patient to create the enclosure.

The shield unit can be quickly deployed in emergency situations, in ICUs, emergency rooms, ambulances as well as non-medical settings. The shield unit can further be quickly removed and re-deployed with a new shield wall 108 given the frame 107 of the shield unit remains uncontaminated, according to embodiments of the present invention. The shield wall 108 according to each embodiment is compatible for use with each of the shield unit embodiments 100A, 100B, 100C as described herein and is removably attachable to each frame 107 from the outer surface of the shield wall 108 so as not to expose the frame 107 to the inner surface of the shield wall 108.

While particular embodiments of the present invention have been shown and described, it will be obvious to those skilled in the art that, based upon the teachings herein, that changes and modifications may be made without departing from these exemplary embodiments of the present invention and its broader aspects. Therefore, the appended claims are intended to encompass within their scope all such changes and modifications as are within the true spirit and scope of this exemplary embodiments of the present invention.

What is claimed is:

1. A portable shield unit to prevent airborne particulate spread extruded from a patient, the portable shield unit comprising:
a portable frame configured to suspend above a patient, the portable frame having a single continuous member or a plurality of members, wherein each member of the plurality of members is coupled to another member of the plurality of members; and
a shield wall configured to drape from the portable frame and around at least a head and an upper torso of the patient, the shield wall having an inner surface and an outer surface, wherein the outer surface of the shield wall is attached to the single continuous member or to the plurality of members of the portable frame, such that the portable frame avoids any contact with the inner surface of the shield wall and is thereby protected from exposure to the airborne particulate extruded from the patient.

2. The portable shield unit according to claim 1, wherein the portable frame further comprises supporting members extending below the portable frame and coupled to the portable frame at an upper end of each of the supporting members.

3. The portable shield unit according to claim 2, wherein the portable frame further comprises mounting members coupled to the supporting members at a lower end of each of the supporting members.

4. The portable shield unit according to claim 3, wherein the mounting members are connected to wheels.

5. The portable shield unit according to claim 1, wherein the plurality of members of the portable frame comprises: a first member, a second member, and a third member;
wherein the first member is coupled at a first junction to the second member and the second member is coupled at a second junction to the third member.

6. The portable shield unit according to claim 5, wherein the first member and the third member are each further connected to an upper end of a supporting member.

7. The portable shield unit according to claim 1, further comprising a hanging component connected to a top of the portable frame.

8. The portable shield unit according to claim 1, wherein the shield wall further comprises at least one set of insertion holes.

9. The portable shield unit according to claim 1, wherein one or more fasteners connects the outer surface of the shield wall to an outside of the plurality of members.

10. The portable shield unit according to claim 1, wherein a material of the shield wall is flexible plastic.

11. The portable shield unit according to claim 1, wherein the portable frame is collapsible.

12. A portable shield unit to prevent airborne particulate spread extruded from a patient, the portable shield unit comprising:
a portable frame having a single continuous member or a plurality of members wherein each member of the plurality of members is coupled to another member of the plurality of members;
a hanging component connecting to a top of the portable frame for suspending the portable frame at a distance above a patient; and
a fluid-impermeable barrier configured to drape from the portable frame and surround at least a head and an upper torso of the patient, the barrier formed of a flexible and see-through material allowing the patient to be viewed from outside the barrier,
wherein the barrier comprises an inner surface and an outer surface, and wherein the outer surface of the barrier is attached to the portable frame, such that the portable frame avoids any contact with the inner surface of the barrier.

13. The portable shield unit according to claim 12, wherein the plurality of members of the portable frame comprises: a first member, a second member, and a third member; wherein the first member is coupled at a first junction to the second member and the second member is coupled at a second junction to the third member.

14. The portable shield unit according to claim 12, wherein the barrier comprises at least one set of arm insertion holes for outside access to the patient surrounded by the barrier.

15. The portable shield unit according to claim 12, wherein the barrier has a height configured to drape a distance from the portable frame to a location below the patient when positioned on a bed or gurney.

16. A method of deploying a portable shield unit comprising a frame and shield wall to prevent airborne particulate spread extruded from a patient, the method of deploying comprising:
a) assembling the frame comprising a single continuous member or a plurality of members;
b) attaching an outer surface of the shield wall to an outside surface of the single continuous frame or to an outside surface of one or more of the plurality of members, to create a shield unit enclosure, wherein the frame is prevented from contacting an inner surface of the shield wall;
c) positioning the shield unit over a desired location.

17. The method according to claim 16, wherein the step of assembling further comprises suspending the frame from an overhead structure via a hanging component connected to a top of the frame.

18. The method of claim 16, wherein the step of assembling comprises at least connecting a first member to a second member using a first coupler and connecting a second member to a third member using a second coupler.

19. The method of claim 16, wherein the step of attaching comprises using fasteners.

20. The method of claim 16, wherein the step of positioning comprises moving the shield unit over an upper torso and a head of the patient to create the shield unit enclosure.
